(19) United States
(12) Patent Application Publication
(10) Pub. No.: US 2024/0232965 A1
(43) Pub. Date: Jul. 11, 2024

(54) Method for creating digital art from photos and videos of coins and various methods of presenting the art to be viewed.

(71) Applicant: Nazareno Cruzada, San Marcos, CA (US)

(72) Inventor: Nazareno Cruzada, San Marcos, CA (US)

(21) Appl. No.: 18/095,531

(22) Filed: Jan. 10, 2023

(51) Int. Cl. G06Q 30/0601; G06V 10/141

(52) U.S. Cl. CPC G06Q 30/0601; G06V 10/141

(57) ABSTRACT

The invention relates to a method of creating digital art from photos and videos of coins and various methods of presenting this art to be viewed. This allows coins to be presented in a more user-friendly way than the traditional methods. These traditional methods include 2×2″ cardboard holders or “flips”, cardboard albums, or plastic holders called “slabs” that are provided by third party grading companies. These traditional methods make it difficult to appreciate the beauty of certain collectible coins because most coins are small and it's hard to see the details with the naked eye. One would have to use a magnifying lens or a jeweler's loupe to see the coin's details. This invention presents the coins for view at hundreds of times magnification and with very good to excellent lighting that accentuates the coin's beauty. Coin collectors can now show their collections in a large frame that can hang on a wall without having to give their guest a magnifying lens or a jeweler's loupe to view the coins.

### BACKGROUND OF THE INVENTION

### 1. Field of the Invention

The invention relates to the field of digital art creation and presentation in the context of coin collecting.

### 2. Description of the Prior Art

The prior art to this invention includes nuTilt Imaging (www.nutilt.com) which has technology that captures digital images of a coin from multiple tilt angles and joining them together to create an animated image. A light source is shone on the coin at an angle and then moved around the circumference of the coin to give the reflected light on the image a spinning or cartwheel effect. This image can then be presented to a viewer via a mobile app or a computer web browser. With the mobile app, the viewer can tilt the mobile phone to induce a change or movement in the image of the coin, similar to tilting a coin in one's hand. With the computer web browser, the viewer can click on buttons and other screen controls to induce these changes.

The nuTilt Imaging technology does not join multiple coin images into a single layout but rather focuses on showing an individual coin by itself. Their technology does not induce view changes or movement to multiple coin images. The nuTilt Imaging technology also does not load the image files into a digital art frame to be viewed via that medium.

The nuTilt Imaging service is only for coins that are graded and encapsulated by a grading company such as NGC or PCGS. They do not accept raw coins for their imaging services. Thus the images show the coin in the plastic holder and the holder's plastic prongs that hold the coin in the center.

### SUMMARY OF THE INVENTION

This invention is a method of creating digital art from photos and videos of raw unholdered coins and various methods of presenting the art to be viewed. The coin is placed at the center of a flat object with a hard surface. This object rests on a second object which is triangular in shape and with its high point or peak positioned at the center of the bottom of the first object. A digital video camera pointed at the center of the coin from the top and a tilt is induced on the first object at each degree all along its circumference. This tilt will result in the light shining on the coin at an angle and this is captured by the video camera as a unique shine effect. This tilt is induced in a clockwise or counter-clockwise rotation, giving the shine a spinning or “cartwheel” effect. If the coin doesn't have a shine but instead has colors, the light shining from multiple different angles of this tilt and rotation will reveal and brighten the colors and give the image of the coin a shimmering or “kaleidoscopic” effect.

Once these dynamic imaging effects are recorded on digital video, a compilation is created from multiple videos joined together into one composite layout. An example is joining together individual videos of 9 coins into a 3×3 layout or of 20 coins into a 5×4 landscape layout. The multiple digital video files are joined together into one digital video file and loaded into a digital art frame to be viewed. When joining together these digital video files into a single layout, their movement and effects can be arranged in different ways so as to give the entire layout variable dynamic movements. An example is to have all the coins spinning in one direction or to have the coins spin one at a time, going from one coin to the next, from top left to the bottom right.

Once the digital video files are created, the art can be presented on hardware devices for viewing using various methods. This includes digital art frames such as those with an LCD or OLED screen, a flat screen TV, a tablet, a laptop, or a regular desktop computer.

### DETAILED DESCRIPTION OF THE INVENTION

This invention is a method of creating digital art from photos and videos of raw unholdered coins and various methods of presenting the art to be viewed. The coin is placed on a hard flat thin object such as a piece of sheet metal, wood or plastic, with a diameter an inch or more larger than the diameter the coin. This first object rests on a second object which is triangular in shape and with its high point or peak positioned at the center of the bottom of the first object. This allows the first object to tilt in any angle along its 360 degree circumference. The hard flat surface of the first object will have a layer of material that absorbs light so as to eliminate any light in the background and focus on the coin. This layer of material can be black velvet or felt.

Once the coin is on this surface, a digital video camera is pointed at the center of the coin from above and an array of multiple light sources arranged in a pattern around the camera shine light on the coin. An example of these multiple light sources are small LED lights. The arrangement of these multiple light sources in a pattern provide a unique light pattern on the coin, which produces a unique shine pattern on the surface of the coin.

Once this configuration is ready, a tilt is induced on the coin. This tilt will result in the light shining on the coin at an angle and this is captured by the video camera as a unique shine effect. This tilt is induced on every degree of the 360 degree circumference of the coin in a clockwise or counter-clockwise rotation, giving the shine a spinning or “cartwheel” effect. If the coin doesn't have a shine but instead has colors, the light shining from multiple different angles of this tilt and rotation will reveal and brighten the colors and give the image of the coin a shimmering or “kaleidoscopic” effect.

Individual digital photos can be taken at each degree of the 360 degree circumference of the coin as the coin is tilted and used to create these effects but digital video is preferred as it is continuous, much easier and more precise in capturing each tilt angle. File formats for digital videos include MP4 and Flash movies.

Once these dynamic imaging effects are recorded on digital video, a compilation is created from multiple videos joined together into one composite layout. An example is joining together individual videos of 9 coins into a 3×3 layout or of 20 coins into a 5×4 landscape layout. The multiple digital video files are joined together into one digital video file and loaded into a digital art frame to be viewed. When joining together these digital video files into a single layout, their movement and effects can be arranged in different ways so as to give the entire layout variable dynamic movements. An example is to have all the coins spinning in one direction or to have the coins spin one at a time, going from one coin to the next, from top left to the bottom right.

The joining together of these multiple digital video images and files into a single layout can be done using a video editing software program. This single layout presentation can also be done within a computer software program or application that presents a multi-sectional singular window to be viewed. This software program or application can be written in a popular computer programming language such as Java or Microsoft .NET and is the type that runs on an operating system such as Linux or Microsoft Windows. This operating system runs on a computer motherboard or circuit board.

Once the digital video files are created and finished, there are various methods of presenting the art to be viewed.

In one embodiment, the digital video files are loaded into the computer memory of a physical digital art frame device and physical buttons on the digital art frame can be used to view a selected file or to go from viewing one file to another or from one variable dynamic movement to another.

In a second embodiment, a physical digital art frame device with a touch screen can be used to present the compilation layout set inside a software program or application window with virtual buttons along the border. The software program files along with the digital video files are loaded into the computer memory of the digital art frame. Once the software program is run, it presents the images in its application window on the screen, and the images inside the compilation layout can then react interactively to a viewer's touch, where the viewer can rotate individual or multiple coins by flicking them with their fingers or using the virtual buttons to go from viewing one file to another. The viewer can flick an image of a coin from side to side or from top to bottom, and the coin's image will change from the front to the back of the coin. The viewer can flick a finger along the outer rim of the coin's image and it will spin momentarily in the same direction as the movement of the finger, then the spin will come to a stop.

In a third embodiment, the digital file can be converted to a non-fungible token or “NFT” by uploading it to an NFT platform website. This NFT can then be viewed via hardware devices such as computer web browser, virtual reality or “VR” goggles, or a video game console. In similar functionality to the second embodiment, if the hardware device allows the viewer to interact virtually with the digital art NFT image, the viewer can induce the same effect as he or she is able to do in the physical realm in second embodiment such as making the coin's image spin or flip front to back or to make all the images spin in one or another direction.

In a fourth embodiment, this NFT file can be bought and sold online via the NFT platform website. Once sold, the NFT's ownership is transferred via the website's transaction functionality. The functionality of the digital art itself remains the same.

### BRIEF DESCRIPTION OF THE DRAWINGS

FIG. 1: An embodiment of the coin digital images capture or recording equipment and configuration.

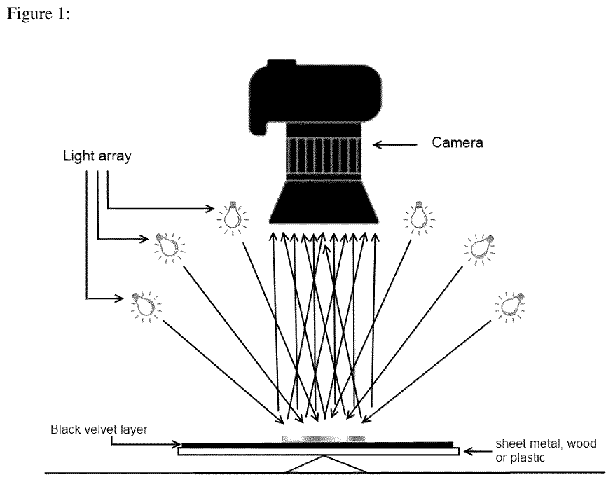

FIG. 2: An embodiment of the process of the coin digital images capture or recording equipment and configuration whereby the coin is tilted and the image is captured or recorded. This tilt is induced all thru the 370 degree circumference of the coin.

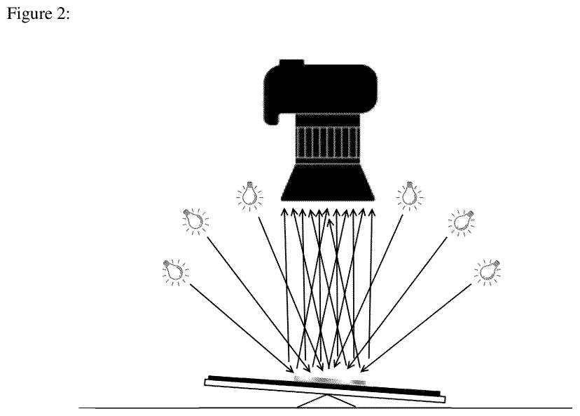

FIG. 3: Another embodiment of the process of the coin digital images capture or recording equipment and configuration whereby the coin is further tilted and the image is captured or recorded. This tilt is induced all thru the 370 degree circumference of the coin.

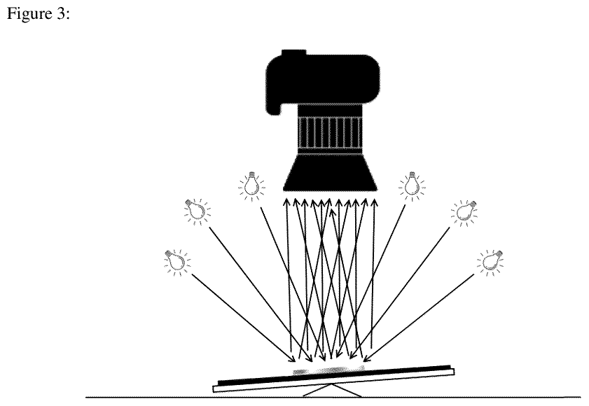

FIG. 4: A framed 3×3 layout of 9 coins. Once the digital art composition is finished, the digital file is loaded into the computer memory of a physical digital art frame such as one with an LCD or OLED screen where the digital art can be viewed on screen. Notice the black background created by using black velvet or felt so that only the coin is showing.

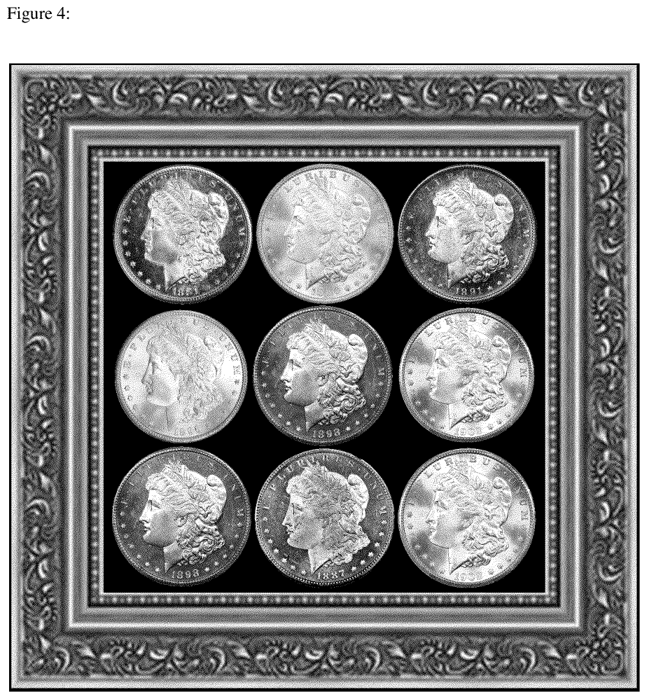

What is claimed is:

1. A method of creating digital art from photos and videos of raw unholdered coins and various methods of presenting the art to be viewed. The coin is placed on a hard flat thin object such as a piece of sheet metal, wood or plastic, with a diameter an inch or more larger than the diameter the coin. This first object rests on a second object which is triangular in shape and with its high point or peak positioned at the center of the bottom of the first object. This allows the first object to tilt in any angle along its 360 degree circumference. The hard flat surface of the first object will have a layer of material that absorbs light so as to eliminate any light in the background and focus on the coin. This layer of material can be black velvet or felt. Once the coin is on this surface, a digital video camera is pointed at the center of the coin from above and an array of multiple light sources arranged in a pattern around the camera shine light on the coin. An example of these multiple light sources are small LED lights. The arrangement of these multiple light sources in a pattern provide a unique light pattern on the coin, which produces a unique shine pattern on the surface of the coin. Once this configuration is ready, a tilt is induced on the coin. This tilt will result in the light shining on the coin at an angle and this is captured by the video camera as a unique shine effect. This tilt is induced on every degree of the 360 degree circumference of the coin in a clockwise or counter-clockwise rotation, giving the shine a spinning or “cartwheel” effect. If the coin doesn't have a shine but instead has colors, the light shining from multiple different angles of this tilt and rotation will reveal and brighten the colors and give the image of the coin a shimmering or “kaleidoscopic” effect. Individual digital photos can be taken at each degree of the 360 degree circumference of the coin as the coin is tilted and used to create these effects but digital video is preferred as it is continuous, much easier and more precise in capturing each tilt angle. Once these dynamic imaging effects are recorded on digital video, a compilation is created from multiple videos joined together into one composite layout. An example is joining together individual videos of 9 coins into a 3×3 layout or of 20 coins into a 5×4 landscape layout. The multiple digital video files are joined together into one digital video file and loaded into a digital art frame to be viewed. When joining together these digital video files into a single layout, their movement and effects can be arranged in different ways so as to give the entire layout variable dynamic movements. An example is to have all the coins spinning in one direction or to have the coins spin one at a time, going from one coin to the next, from top left to the bottom right. Once the digital video files are created and finished, there are various methods of presenting the art to be viewed.

2. A method of claim 1 wherein the joining together of these multiple digital video images and files into a single layout can be done using a video editing software program.

3. A method of claim 1 wherein the joining together of these multiple digital video images and files into a single layout can be done within a computer software program or application that presents a multi-sectional singular window to be viewed. This software program or application can be written in a popular computer programming language such as Java or Microsoft .NET and is the type that runs on an operating system such as Linux or Microsoft Windows. This operating system runs on a computer motherboard or circuit board.

4. An embodiment of claim 1 wherein the digital video files are loaded into the computer memory of a physical digital art frame device and physical buttons on the digital art frame can be used to view a selected file or to go from viewing one file to another or from one variable dynamic movement to another.

5. An embodiment of claim 1 wherein a physical digital art frame device with a touch screen can be used to present the compilation layout set inside a software program or application window with virtual buttons along the border. The software program files along with the digital video files are loaded into the computer memory of the digital art frame. Once the software program is run, it presents the images in its application window on the screen, and the images inside the compilation layout can then react interactively to a viewer's touch, where the viewer can rotate individual or multiple coins by flicking them with their fingers or using the virtual buttons to go from viewing one file to another. The viewer can flick an image of a coin from side to side or from top to bottom, and the coin's image will change from the front to the back of the coin. The viewer can flick a finger along the outer rim of the coin's image and it will spin momentarily in the same direction as the movement of the finger, then the spin will come to a stop.

6. An embodiment of claim 1 wherein the digital file can be converted to a non-fungible token or “NFT” by uploading it to an NFT platform website. This NFT can then be viewed via hardware devices such as computer web browser, virtual reality or “VR” goggles, or a video game console. In similar functionality to the second embodiment, if the hardware device allows the viewer to interact virtually with the digital art NFT image, the viewer can induce the same effect as he or she is able to do in the physical realm in second embodiment such as making the coin's image spin or flip front to back or to make all the images spin in one or another direction.

7. An embodiment of claim 6 wherein the NFT file can be bought and sold online via the NFT platform website. Once sold, the NFT's ownership is transferred via the website's transaction functionality. The functionality of the digital art itself remains the same.
